(19) United States
(12) Patent Application Publication
(10) Pub. No.: US 2023/0014285 A1
(43) Pub. Date: Jan. 19, 2023

(54) ULTRA-BROADBAND, HIGH EFFICIENCY, AND POLARIZATION-INDEPENDENT ACHROMATIC METALENS

(71) Applicant: THE REGENTS OF THE UNIVERSITY OF CALIFORNIA, OAKLAND, CA (US)

(72) Inventors: Boubacar Kante, Orinda, CA (US); Abdoulaye Ndao, El Cerrito, CA (US); Li-Yi Hsu, El Cerrito, CA (US); Jeongho Ha, Richmond, CA (US)

(21) Appl. No.: 17/779,727

(22) PCT Filed: Nov. 23, 2020
(86) PCT No.: PCT/US20/61742

§ 371 Date: May 25, 2022

Related U.S. Application Data
(60) Provisional application No. 62/941,077, filed on Nov. 27, 2019.

(51) Int. Cl. G02B 1/00; G02B 3/08

(52) U.S. Cl. CPC G02B 1/002; G02B 3/08; B82Y 20/00

(57) ABSTRACT

An octave bandwidth, achromatic metalens configured to operate in light wavelengths having a range of approximately 640 nm to 1200 nm.

### CROSS REFERENCE TO RELATED APPLICATION

This application claims priority to and the benefit of US Provisional Application No. 62/941,077 filed Nov. 27, 2019, which is incorporated herein by reference in its entirety.

### STATEMENT REGARDING FEDERALLY SPONSORED RESEARCH AND DEVELOPMENT

This invention was made with government support under Grant Number DEEE0007341 awarded by the US Department of Energy. The government has certain rights in the invention.

### TECHNICAL FIELD

This disclosure relates to the use of metasurfaces, more particularly the use of metasurfaces as meta-lenses.

### BACKGROUND

Since the first publication of Newton's discoveries on the decomposition of white light by prism and color theory, optical dispersion continues to fascinate the scientific world. Optical dispersion is one of the fundamental properties of optical components, which can be useful for many applications such as mode locking laser, prism spectroscopy light splitting. However, optical imaging faces a major challenge: chromatic aberration resulting from optical dispersion. Chromatic aberration is generally due to the variation of the refractive index of the material of the optical components as a function of the wavelength of the light passing through them. This chromatic aberration limits the performance of broadband optical applications. To overcome these limitations, conventional optical bulky lens often uses an appropriate combination of multiple lenses. Although these methods can considerably reduce the chromatic aberration, however, these methods are bulky, expensive and wavelength limited. In addition, due to the context of stringent requirements in terms of miniaturization and further integration of heterogeneous optical and electronic functions, considerations regarding system compatibility and size without chromatic aberration become a major issue. Recent advances made in photonics, both in understanding physical phenomena and in the control of fabrication processes, have contributed to improved detection capabilities in terms of multi-functionality and miniaturization.

To face these challenges, metasurfaces have been investigated as potential alternatives for integrated optical free space components. Metasurfaces are subwavelength nanostructured devices that enable the control of optical wave fronts, polarization, and phase. A large variety of flat optical components, including planar lenses, holograms quarter-wave plates, half wave plates, optical vortex plates, carpet cloaks, solar concentrators, polarizers, thin absorbers, biomedical imaging devices, and or sensors.

Although, metasurfaces appear as the most promising way to overcome these aforementioned lacks and achieve new functionalities, however, mitigating chromatic aberration at micrometer scale remains a fundamental problem for current metasurfaces. To date, multiple wavelengths, and broadband achromatic metalens have been recently reported in to reduce monochromatic aberration. However, the currently proposed devices are so far limited within discrete wavelengths, such as a bandwidth from 470 to 670 nm with an efficiency of 20%, and a bandwidth from 400 nm to 660 nm with average efficiency around 40%.

### BRIEF DESCRIPTION OF THE DRAWINGS

FIG. 1A shows an embodiment of a fishnet achromatic metalens and unit cell.

FIG. 1B shows a top view and a zoomed view of an optical microscope image of a fabricated fishnet achromatic.

FIG. 2 shows graphical representations of the results of controlling design parameters.

FIG. 3 shows a graphical representation of an embodiment of a design process.

FIG. 4 shows a flow chart of a method of manufacturing a fishnet achromatic metalens.

FIG. 5 shows a graph of an efficiency change with non-zero phase-shift intercepts in the metalens.

FIG. 6 shows an embodiment of an imaging and illumination system.

FIG. 7 shows experimental demonstration of achromatic and broadband focusing by a fishnet achromatic metalens.

FIG. 8 shows scanning electron microscope images of different diameters of metalenses.

FIG. 9 shows a graph of focal length versus wavelength for different diameters of metalenses.

FIG. 10 shows a graph of efficiency versus wavelength for different diameters of metalenses.

FIG. 11 shows a graph of Strehl ratio versus wavelength for different diameters of metalenses.

FIG. 12 shows graphs of focal length and efficiency versus wavelength for X and Y polarities of a metalens.

### DETAILED DESCRIPTION OF THE EMBODIMENTS

Metasurfaces attract a continuously growing interest in the last few years because of their fascinating ability to manipulate optical phase front resulting in many different applications. However, mitigating chromatic aberration at micrometer scale for broad wavelength range using metasurfaces remains a fundamental problem for optical components and imaging applications. These fundamental limitations are in general due to the intrinsic optical properties of the employed materials, and the fundamental design principle. The embodiments here propose and experimentally demonstrate for a first time a new method based on a new design principle to engineer ultra-high efficiencies and polarization-independent fishnet-achromatic metalenses (FAM) with efficiencies of over 70% in the continuous band from visible (640 nm) to infrared (1200 nm) Such devices pave a new way for new functionalities that require ultra-broadband polarization-independent achromatic metalens with high efficiency.

The embodiments here employ a new design principle based on a TiO₂ nanostructure. One should note that the use of TiO₂ provides merely one possibility and the discussion has no intention to limit materials to that specific example nor should one so imply. The embodiments simultaneously control the slope and the phase-shift-intercept, two parameters that need continuous optimization for achromatic operation. Experimental Strehl ratios larger than 80% are measured in the octave bandwidth demonstrating diffraction-limited operation, where the octave bandwidth is from a first bandwidth to twice that bandwidth.

In order to focus light to a point for a normal incident plane wave, a flat lens needs to deflect light by a position (r) dependent angle (θ) given by the relation:

$$sin ( θ ) = \frac{r}{\sqrt{{r}^{2} + {F}^{2}}} = \frac{1}{{k}_{0}} \frac{d ϕ ( r , f )}{{d}_{r}} , i . e \qquad ( 1 )$$

$$ϕ ( r , f ) = \int d r {k}_{0} \frac{r}{\sqrt{{r}^{2} + {F}^{2}}} = = - \frac{2 π f}{c} ( \sqrt{{r}^{2} + {F}^{2}} - F ) + g ,$$

where ∅(r, ƒ) is the phase profile required, ƒ is the frequency, F is the focal length, r is the radial position, c is the speed of light, and g is a reference phase function independent of r.

The reference phase can be an arbitrary function of frequency because only the spatial phase difference matters for the interference of waves at the same frequency after their interaction with the lens. One can then consider the phase shift, the phase difference between the local phase and the phase at the reference position taken at r=0, the center of the lens. The phase-shift equation for a normal incident wave Δ∅(r,ƒ) is:

$$\begin{matrix}Δ ϕ ( r , f ) = ϕ ( r , f ) - ( 0 , f ) = - \frac{2 π}{c} ( \sqrt{{r}^{2} + {F}^{2}} - F ) f \\ = m ( r ) f , m ( r ) = - \frac{2 π}{c} \sqrt{{r}^{2} + {F}^{2}} - F )\end{matrix} \qquad ( 2 )$$

where m(r) is the frequency slope of the phase-shift.

Equation 2 reveals the requirements of a broadband achromatic metalens. First, the phase-shift is linear respect with frequency. This condition can be locally satisfied using waveguide models. Second, the frequency slope, referred to here as the slope, of the phase-shift (dispersion) varies with position follow Equation 2. The phase-shift Δ∅(r,ƒ) is proportional to frequency, meaning the phase-shift intercept with respect to frequency is 0. The metasurface becomes a waveguide array with, ideally, a local and simultaneous control of the slope and the intercept of the phase-shift.

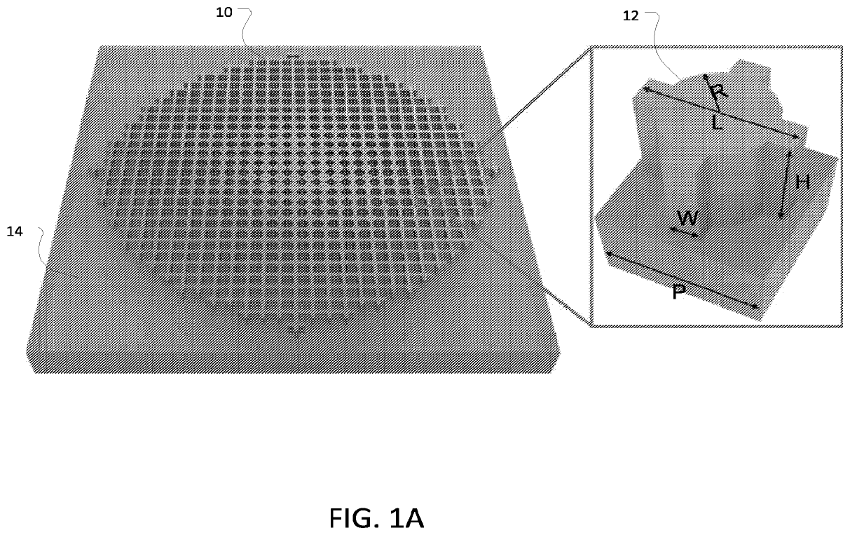

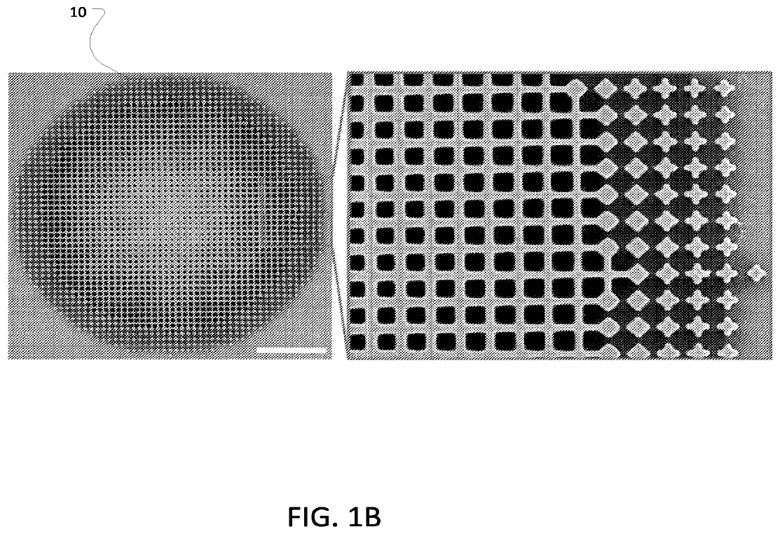

To satisfy the requirements of achromatic broadband metalenses, the embodiments use a cross-circle waveguide as shown in FIG. 1A as building block, or unit cell 12. The building block has four geometrical parameters that are the radius (R), the width (W), the length (L), and the period (P) of the repeating unit cell 10 to form the metalens 10 on substrate at 14. Constraints impose for example W≤2R and L≤P. Using geometric parameters, the slope can be controlled with a quasi-control of the phase-shift intercept consisting of minimizing it (ideally zero). Because each position has a unique (slope, phase-shift intercept) coordinate, dimensions can be chosen accordingly.

The unit cell has a cylindrical portion with four extensions that connect one unit cell to the other unit cells. The unit cell is referred to as having a radius (R), which is the radius of the cylindrical portion but is considered to be the radius of the structure. It has a length (L) that is the length from one end to the other of the extensions, and a width (W) that is the width of the extensions. The height (11) is the height of the unit cell structure.

One of the unique aspects of the device is that the design accounts for modified near-field interactions that may hinder the performance of metalenses. This is done via the iso-slopes and iso-phase-shift intercepts used in the construction of the metasurfaces of the embodiments. It is important to note that the four geometric parameters are not independent, as a change in any of them can affect the effective index of the waveguide they form. This signifies that it is challenging to have perfect achromaticity and efficiency as phase-shift intercepts and slopes cannot be fully independently controlled in a planar design. The limitation confirms that this is intrinsically an optimization problem.

In metasurfaces, the spatial derivative of the slope controls the direction of incident rays to make them reach the focal point. It is thus important to have the correct slope to prevent chromatic effects and a decrease in efficiency. The intercept, however, controls the superposition of waves at the focal point, i.e., mostly affects the efficiency of the lens, not the position of the focal length. One can compromise on the intercept in the design of the lens. To quantify the impact of a non-zero phase-shift intercept on the efficiency of the metalens of the embodiments, Monte Carlo simulations are performed with 100 simulations for each element using a homemade finite difference time domain code. Each simulation was given a certain magnitude of the phase-shift intercept (error or deviation from the ideally zero phase-shift intercept) that was randomly distributed between unit-cells. The focusing efficiency was then compared to the ideal metalens implementing not only the correct slope but also the correct phase-shift intercept. Results indicate that an error on the phase-shift intercept smaller than 30° decreases the efficiency of the metalens by <10% and does not affect the position of the focal point.

FIG. 1A shows view of the metasurface, also referred to as the metalens 10, on a substrate 14, and the geometry of the unit-cell 12 with multiple degrees of freedom. It is a fishnet-like structure with a period P=370 nm and a height H=350 nm. The structure is fabricated by top-down nano-manufacturing methods and a scanning electron micrograph (SEM) of a fabricated metalens is shown in FIG. 1B. The period indicates that the unit cells repeat every X nanometer or micrometers.

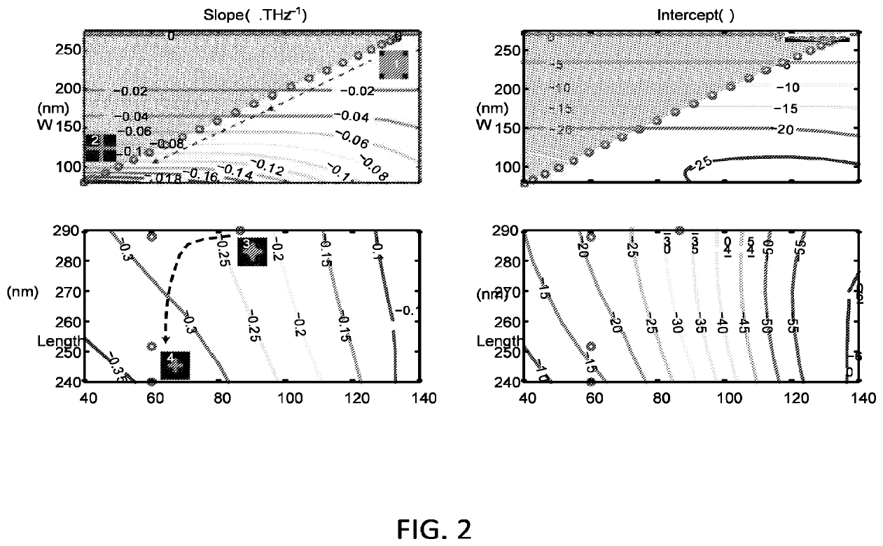

To design the metasurface embodiments here, geometric parameters are controlled by pair, (W, R) in FIG. 2 in the top two graphs and (L, R) in FIG. 2, the lower two graphs. By considering fabrication limits, iso-slopes and iso-phase-shift intercept plots of realistic geometries are computed using full-wave numerical simulations (CST Microwave Studio) and the local phase method, followed by least-square linear fitting. The phase shift of elements is calculated using a reference at the center of the lens with geometric parameters W=270 nm, R=135 nm, and L=P=370 nm. For all other geometries, the parameters in FIG. 2 are calculated.

The two graphs of FIG. 2 show that changes in R, W, and L enable slopes from zero to −0.3520 THz-1 which in turn determines the maximum achievable size of the metalens for a given focal length. The figure also confirms that it is not possible to fully independently control the slope and the phase shift-intercept. However, accepting an error on the phase shift intercept enables designs sweeping all slope values. FIG. 2 in the upper left enables slopes from zero to −0.2° THz-1 while keeping a phase-shift intercept error below 30° as shown in the upper right. For the 20 μm×20 μm metalens, one example has chosen points indicated in blue (along the black arrow) to minimize discretization errors and points in the gray area are not geometrically allowed as W≥2R.

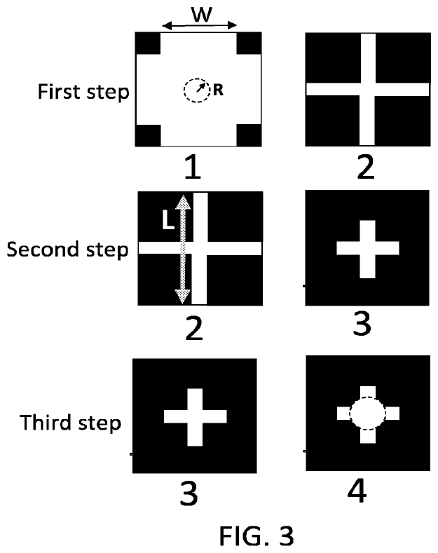

For absolute value of slopes larger than 0.2° THz-1, the embodiments used parameters in the lower left of FIG. 2 and the second trajectory (blue points along the black arrow) also keeps the phase-shift intercept error below 30° as shown in the bottom right of FIG. 2. The evolution of the geometry of the unit-cell from the center of the lens to its edge is further discussed in supplementary information. The red box and red/black graphics shown correspond to the graphics shown in FIG. 3.

FIG. 3 shows an evolution of an embodiment of a unit-cell, the base structure 12 from FIG. 1, the repetition of which makes up the metalens. The red color indicates the material of the structure and the black color indicates the substrate upon which it is built. Starting in the top left, the radius R and the width W changed. When the width is larger than the diameter (W>2R), the change of the radius cannot be seen in the geometry as the cylinder is embedded in the square. Therefore, the region (W>2R) is shadowed as only W is relevant in that region. In the middle of FIG. 3, the length of the bridge, and on the bottom, a cylinder was added, which gave a new degree of freedom. By changing the radius, one can see the cylinder.

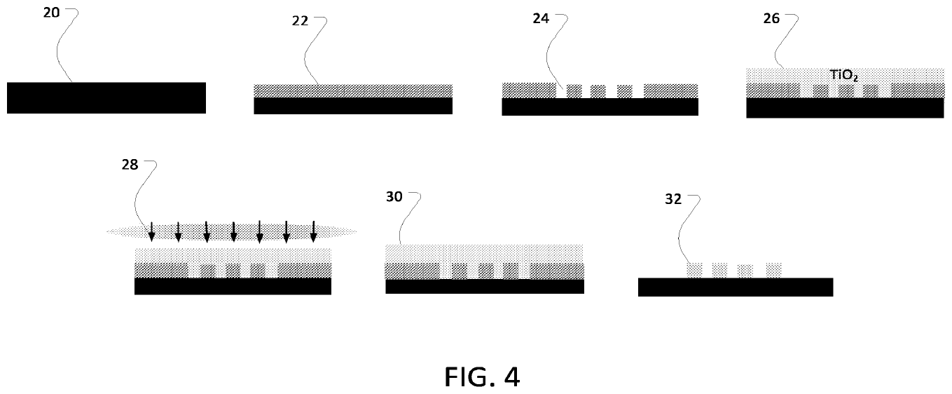

FIG. 4 shows a method of manufacturing the FAM. First, a substrate, typically glass or other transparent material is cleaned at 20. This may include an O₂ plasma treatment to increase the adhesion between the substrate and other materials such as resist and the structural material. At 22, a resist is coated onto the substrate. In one embodiment the resist may be an electron beam resist. In one embodiment, the resist may be polymethyl methacrylate (PMMA) patternable with electron beam lithography. The resist may undergo baking on a hot plate or other heat source.

At 24, the resist is patterned to form an inverse pattern to the final metasurface pattern. In one embodiment, the resist undergoes electron beam lithography to form the inverse pattern. The patterning may involve use of a solution to develop the pattern. At 26, the structural material for the metasurfaces is deposited to form the desired pattern. In one embodiment, the exposed sample is transferred to an atomic layer deposition (ALD) chamber. The ALD process deposits 350 nm of structural material so that all features are filled. In one embodiment the structural material is titanium oxide (TiO₂).

After deposition of the structural material, the process removes the residual structural material. In one embodiment, removal may involve reactive-ion etching as shown at 28. One embodiment may include using BCL₃ and CL₂ gasses in that process. The etch depth used in whatever process is the depth of the film, so the etching process exposes the underlying resist and the top of the nanostructures as shown at 30. Finally, the process removes any remaining resist, at 30, leaving only the metasurfaces of the structural material on the substrate as shown at 32.

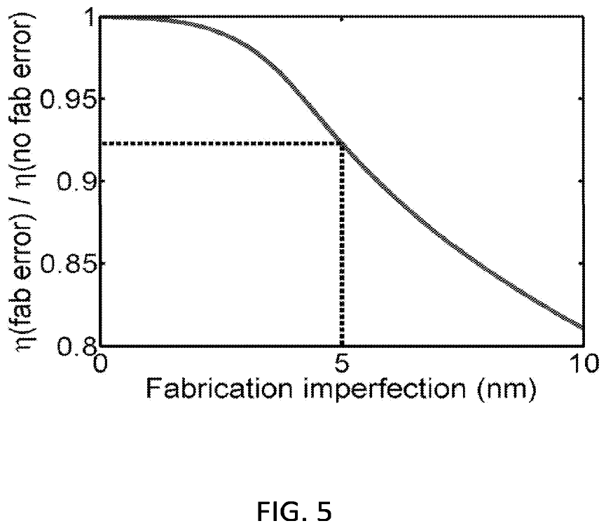

It is worth noting that FAMs have mostly connected structures and are thus more stable mechanically than metasurfaces based on fully disconnected elements. Fabrication imperfections with a magnitude of ±5 nm decrease the efficiency by at most 8%, making the FAMs robust as shown in FIG. 5.

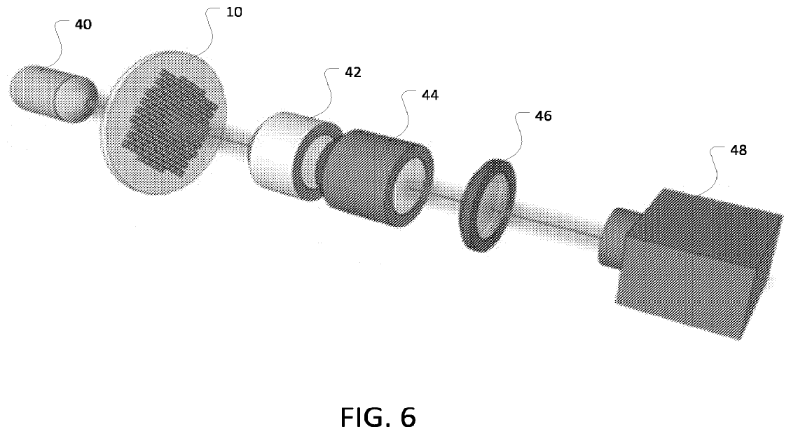

The fabricated metalenses were optically characterized using a custom setup consisting of two main systems dedicated to illumination and imaging as shown in FIG. 6. Generally, the setup consists of a laser 40, a microscope object lens 42, a tube lens 44, an iris 46 and a camera 48. In specific embodiments, the illumination system comprises a supercontinuum laser 40 and an acousto-optic tunable filter to select the operating wavelength. For the imaging system, a ×50 extra-long working distance microscope objective lens 42 with a numerical aperture of 0.65 and a tube lens 44 with a focal distance of 20 cm were used to image planes of interest on a camera 48. To image the focusing pattern, the system moved the sample around the focal point using a translation stage.

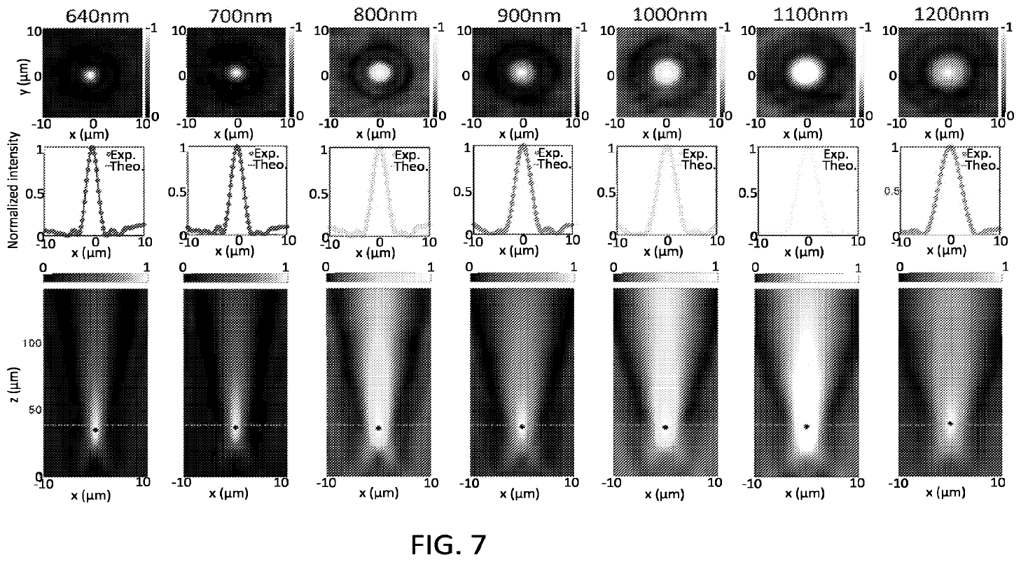

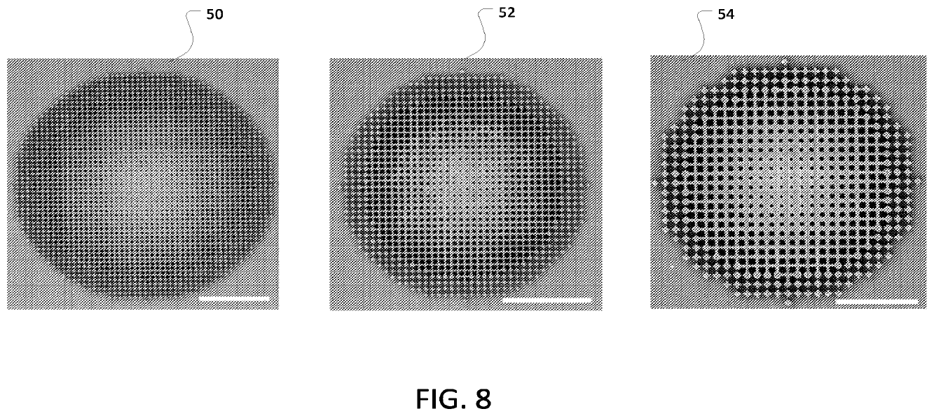

FIG. 7 presents the measured intensity profiles in the focal plane z=F (transverse x-y plane) of the metalenses at different wavelengths along the top of the figure. The dots on the graphs in the middle of FIG. 7 represent a normalized cross-section of the experimental measurements and the lines correspond to the theoretical Airy disk. The bottom of FIG. 7 shows the normalized intensity profiles in the plane y=0 (axial x—z plane) around the focal point of the metalens at different wavelengths. Black circles represent the focal spots for different wavelengths. These results show nearly diffraction-limited focal spots with no obvious distortion. To further examine the performance of designed metalenses, one can measure focal lengths, focusing efficiencies, and full widths at half maximum (FWHM) for different lens diameters as shown in FIGS. 8-11.

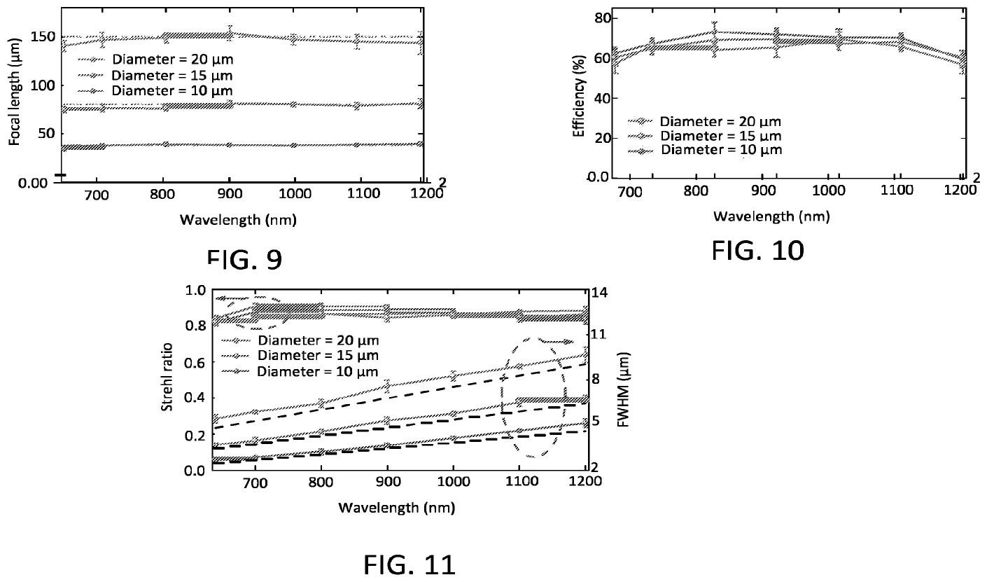

FIG. 8 presents SEM images of lenses of diameters 10, 15, and 20 μm at 50, 52 and 54, respectively. FIGS. 9-11 present different performance characteristics of these lenses. FIG. 9 presents the focal length of the metalenses with the 20 μm being the top line, and the 10 μm being the bottom, and shows that they are mostly unchanged when the wavelength varies from 640 to 1200 nm, demonstrating the successful realization of the broadband achromatic property. FIG. 10 presents the focusing efficiency for metasurfaces of different diameters and focal lengths, with the 20 μm being the bottom line and the 10 μm being the top line. To enable a quantitative comparison between the devices of the embodiments and previously reported metalenses, one can define the size of the focal spot as three times the FWHM (full-width half-maximum) in the measurements of the efficiencies. The measured efficiency of a metalens is defined as the focal spot power divided by the transmitted power through an aperture of the same diameter as the metalens. Efficiencies from 65% to 75% for the entire band are measured. In FIG. 11, right axis, the experimental FWHM plots of the focal spots are presented, with the 20 μm lens being the top line and 10 μm being the bottom. Also presented in FIG. 22, left axis, the Strehl ration is compared against the wavelength. The Strehl ratio is defined as the ratio of the peak focal spot irradiance of the manufactured FAMs to the focal spot irradiance of an aberration-free lens. The calculation includes the total energy enclosed by the measured focal spot within a diameter up to the second dark ring of corresponding airy disk.

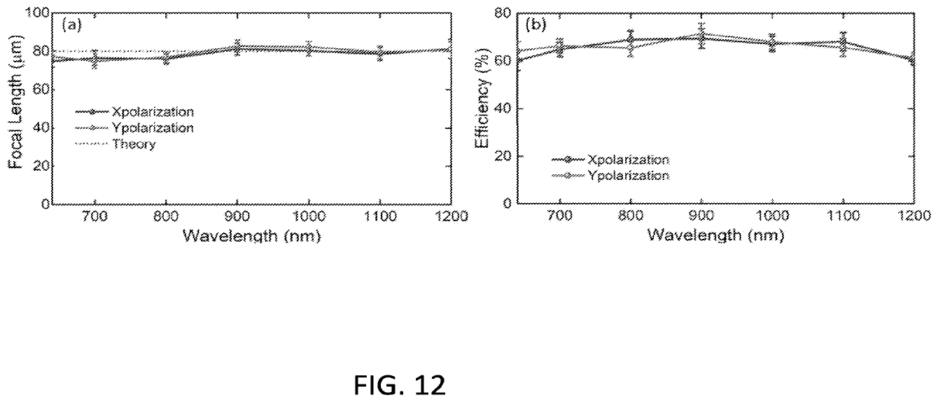

These results show that FAMs successfully achieve a diffraction-limited focus. Similar results are obtained for the X and Y polarization confirming polarization independence as shown in FIG. 12. Beyond the extremities of the current bandwidth, the slopes are smaller than the target slopes at different positions owing to the dispersion of TiO₂ and leading to an increased focal length. The embodiments have successfully implemented planar achromatic metalenses spanning the continuous wavelength range from 640 nm in the visible to 1200 nm in the infrared.

To compare metasurfaces operating in various wavelengths range, a fair metric is the fractional bandwidth defined as the bandwidth divided by the central frequency, i.e., Δλ/λ_{center}=Δf/f_{center}with Δλ=λₘₐₓ−λₘᵢₙ and λ_{center}=(λₘₐₓ+λₘᵢₙ)/2. The FAMs of the embodiments have a fractional bandwidth of 61% with an efficiency of 70%. The FAMs here have higher efficiencies and larger fractional bandwidths, such as at least 61%, than other experimentally reported metasurfaces. Moreover, compared to multi-level diffractive lenses, the FAMs can be extended to anisotropic structures to enable functions not easily achieved with diffractive elements.

Metalenses have the advantage to enable subwavelength unit-cells which usually come at the price of the bandwidth and efficiency and this tradeoff is overcome in our design. Large scale metalenses are of technological importance. FAMs can be implemented at larger scale by increasing the maximum slope which will require higher aspect ratio. State of the art diffractive optics experiments have an efficiency of 35% and a fractional bandwidth of 62.7%37. It is worth noting that metalenses have larger angular transmission compared to Fresnel lenses, which suffer from the shadowing effect due to their sawtooth surface profile. The embodiments bring metasurfaces to a performance level not previously reached.

In summary, the embodiments proposed and experimentally demonstrate metalenses combining high efficiency, polarization independence, and achromaticity in the continuous wavelength range from 640 nm in the visible to 1200 nm in the infrared. The broadband operation is achieved by enforcing the slopes of the phase-shift that vary continuously from the center of the lens to its edge, and, by minimizing the phase-shift intercepts that are ideally zero for achromatic operation. To the best of the inventors' knowledge, this is the broadest band achromatic metalens reported to date. The proposed approach significantly extends the current state of the art of metalenses both in terms of bandwidth and efficiency and opens the door to many applications.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the claims.

What is claimed is:

1. A fishnet achromatic metalens configured to operate in light wavelengths having a range of approximately 640 nm to 1200 nm.

2. The metalens as claimed in claim 1, wherein the metalens is comprised of a repeated unit cell.

3. The metalens as claimed in claim 2, wherein the unit cell has geometric parameters of length, width, height, and radius, and the index of the metalens is based on the geometric parameters.

4. The metalens as claimed in claim 3, wherein the radius is 135 nanometers, the width is 270 nanometers, and the length and the period are both equal to 370 nanometers.

5. The metalens as claimed in claim 1, the metalens having a phase-shift intercept based upon a focal length and radial position of the metalens, and the frequency of the light, wherein the phase-shift has an error of less than 30 degrees.

6. The metalens as claimed in claim 2, wherein the width is less than or equal to two times the radius.

7. The metalens as claimed in claim 1, wherein the metalens has an efficiency of at least 65%.

8. The metalens as claimed in claim 1, wherein the metalens has a fractional bandwidth of at least 61%.

9. A method of manufacturing a fishnet achromatic metalens, comprising:
cleaning a substrate;
depositing a resist on the substrate;
patterning the resist with a pattern that is an inverse of a pattern for the metalens;
depositing a structural material in the pattern for the metalens;
removing residual structural material; and
removing residual resist to leave the metalens on the substrate.

10. The method as claimed in claim 9, wherein cleaning the substrate comprises cleaning a glass substrate.

11. The method as claimed in claim 9, wherein cleaning the substrate comprises an 02 plasma treatment.

12. The method as claimed in claim 9, wherein depositing a resist comprises depositing an electron beam lithography resist.

13. The method as claimed in claim 12, wherein patterning the resist comprises applying electron beam lithography to the resist and developing the pattern with a solution.

14. The method as claimed in claim 9, wherein depositing the structural material comprises depositing titanium oxide

15. The method as claimed in claim 9, wherein depositing the structural material comprises using atomic layer deposition.

16. The method as claimed in claim 9, wherein removing the residual structural material comprises performing reactive-ion etching.
